(19) United States
(12) Patent Application Publication
(10) Pub. No.: US 2024/0078035 A1
(43) Pub. Date: Mar. 7, 2024

(54) WRITE-BACK RESCHEDULING

(71) Applicant: Arm Limited, Cambridge (GB)

(72) Inventors: Xiaoyang SHEN, Valbonne (FR); Zichao XIE, Cambourne (GB); Leonardo INTESA, Antibes (FR)

(21) Appl. No.: 17/900,975

(22) Filed: Sep. 1, 2022

(51) Int. Cl. G06F 3/06

(52) U.S. Cl. CPC G06F 3/0655; G06F 3/0604; G06F 3/0673

(57) ABSTRACT

An apparatus has processing circuitry with one or more execution units to perform operations in response to instructions. The apparatus also has registers to store data accessed by the processing circuitry and forwarding circuitry to forward results of the operations from the execution units to be written back to the registers and to the execution units for use as operands of further operations. The apparatus also has write-back reschedule circuitry which for each operation causes an execution unit performing the operation to stall the operation prior to a write-back stage of the execution unit and determine, based on monitoring subsequent operations whether to forward the result of the operation to be written back to a register or to forward the result to an execution unit. The write-back reschedule circuitry also controls the forwarding circuitry to forward the result according to the determination.

### BACKGROUND

The present technique relates to the field of data processing. More particularly, the present technique relates to controlling write-back from execution units to registers.

In a data processing apparatus, results generated by processing circuitry are typically written-back to registers once the result of the operation has been calculated. From there the result may be used by the same or other execution units as the input to a further calculation or may for example be written to memory. By writing-back the result to the registers, the result can be accessed by upcoming operations that read from the register to which the result is stored.

### SUMMARY

In one example arrangement, there is provided an apparatus comprising: processing circuitry comprising one or more execution units, the one or more execution units configured to perform operations in response to instructions; one or more registers to store data accessed by the processing circuitry; forwarding circuitry to selectively forward results of the operations from the one or more execution units to be written back to the one or more registers and to the one or more execution units for use as operands of further operations; write-back reschedule circuitry configured to, for each operation: cause an execution unit performing the operation to stall the operation prior to a write-back stage of the execution unit, wherein stalling the operation prevents a result of the operation being written back to the registers while the operation is stalled; determine, based on monitoring subsequent operations to be performed by the processing circuitry, whether to forward the result of the operation to be written back to a register of the one or more registers or to forward the result to an execution unit of the one or more execution units; and control the forwarding circuitry to forward the result according to the determination.

In another example arrangement, there is provided a method of rescheduling write-back of operations, the method comprising: performing, by one or more execution units, operations in response to instructions; storing, by one or more registers, data accessed for performing the operations; selectively forwarding results of the operations to be written back to the one or more registers and to the one or more execution units for use as operands of further operations; and for each operation: stalling the operation prior to a write-back stage of an execution performing the operation, wherein stalling the operation prevents a result of the operation being written back to the registers while the operation is stalled; determining, based on monitoring subsequent operations to be performed, whether to forward the result of the operation to be written back to a register of the one or more registers or to forward the result to an execution unit of the one or more execution units; and forwarding the result according to the determination.

In a yet further example arrangement, there is provided a non-transitory computer-readable medium to store computer-readable code for fabrication of an apparatus comprising: processing circuitry comprising one or more execution units, the one or more execution units configured to perform operations in response to instructions; one or more registers to store data accessed by the processing circuitry; forwarding circuitry to selectively forward results of the operations from the one or more execution units to be written back to the one or more registers and to the one or more execution units for use as operands of further operations; write-back reschedule circuitry configured to, for each operation: cause an execution unit performing the operation to stall the operation prior to a write-back stage of the execution unit, wherein stalling the operation prevents a result of the operation being written back to the registers while the operation is stalled; determine, based on monitoring subsequent operations to be performed by the processing circuitry, whether to forward the result of the operation to be written back to a register of the one or more registers or to forward the result to an execution unit of the one or more execution units; and control the forwarding circuitry to forward the result according to the determination.

### BRIEF DESCRIPTION OF THE DRAWINGS

Further aspects, features, and advantages of the present technique will be apparent from the following description of examples, which is to be read in conjunction with the accompanying drawings, in which:

FIG. 1 schematically illustrates an example of an apparatus according to an example;

FIG. 2 is a more detailed schematic illustration of various components of FIG. 1 in more detail and includes the matrix processing circuitry, write-back reschedule circuitry and data location tracking circuitry;

FIG. 3 is a timing diagram with a worked example where results are forwarded from an execution unit to be used as the operand of a subsequent operation;

FIG. 4 is a timing diagram with a worked example where a result is forwarded to be written-back;

FIG. 5 is a timing diagram with a worked example where write-back of results is rescheduled to avoid a write-back conflict;

FIG. 6 schematically illustrates an entry in the information maintained by the data location tracking circuitry; and

FIG. 7 is a flow diagram illustrating the re-scheduling of write-back for a particular operation.

### DESCRIPTION OF EXAMPLES

Before discussing the embodiments with reference to the accompanying figures, the following description of embodiments is provided.

As mentioned above, once the result of an operation being processed by the processing circuitry of a data processing apparatus has been calculated, the result may be written-back to registers. This allows the result to be accessed for use in further operations or for storing to memory, for example.

However, the inventors recognised that in some cases the result of a calculation need not be written-back to registers. For example, if the result would later be overwritten before being accessed, there is no need to return this result to the register. This may be the case where a subsequent operation being handled by the processing circuitry leads to data being stored in the same register as the one to which the result would be written prior to any other operation reading from that register. In such a case, the apparatus does not need to write-back the result to the registers.

Even if another operation does make use of the result, in some cases it is possible to avoid the need to write-back the result to the registers only to then read the result back from the registers. Rather, in accordance with the techniques described herein, the result may be forwarded directly to the element of processing circuitry that is to make use of that result as its input, avoiding writing-back the result to the registers.

Where that result would later be overwritten itself, it may be possible to avoid writing-back the result to the registers at all. This situation may arise if the result of the operation is to be used as in the input of a subsequent operation shortly after the original operation was carried out, e.g., in an accumulation situation where instructions to be executed by the processing circuitry indicate that a particular register is to be repeatedly updated, with that updated value used to calculate a new result to be written-back to the same register, thereby over-writing the previous value in that register. In such a case, the apparatus may avoid writing-back the result to the register and instead forward the result of each operation directly to the processing circuitry to use as the input of the next operation.

Since the process of writing-back results to the register bank consumes energy and takes time to complete, this approach may reduce the power consumption of the apparatus and/or allow calculations being handled by the apparatus to be executed more quickly.

Additionally, where an apparatus is provided with processing circuitry comprising multiple execution units, forwarding circuitry to enable forwarding of results from the execution units to the registers may become complicated. Specifically, a large number of paths may need to be provided to connect the execution units to the registers, and circuitry to enable the ability to provide separate control signals to cause each result to be written-back to an appropriate register may need to be provided. However, by identifying where the write-back of results to registers can be avoided and by enabling forwarding of results directly from the execution units to be used as the inputs to other execution units, the complexity of the forwarding operation between the execution units and the registers can be reduced.

In accordance with the techniques described herein, there is therefore provided an apparatus that is able to stall operations at a stage prior to a write-back stage, thereby temporarily preventing the result of the operation from being written-back to the registers. This may be done at a penultimate or final stage of an execution unit handling the operation or may in general be done at any stage in the execution unit prior to the write-back. Where reference is made herein to the last stage of the execution unit, it will be appreciated that the techniques discussed herein may be applied where the operation is stalled at other stages prior to the write-back. By stalling the operation at a stage immediately prior to the write-back stage of the execution unit, the otherwise already calculated result can be held ready for forwarding when it is determined that the result is to be forwarded. The execution unit can keep the operation at this stage until another operation comes to a stage immediately preceding this stage such that the result of the stalled operation would overwritten if it is not forwarded. At this point, the processing circuitry could either allow the result of the stalled operation be overwritten if that result is no longer needed (e.g., if it would have been overwritten in the register had it been written-back) or if the result was still needed, the result could be written-back to the registers at this point.

If a subsequent operation being executed by the same or by a different execution unit of the processing circuitry overwrites the result of that operation while the operation is stalled, the result can be forwarded directly to that execution unit for use as the operand of that subsequent operation, thereby avoiding the need to write-back the result to a register and then read the result from that register.

Thus, the result of a calculation does not necessarily need to be written-back from the execution units to the register bank but can be kept at the last stage of an execution unit until a new operation come to a stage right before the last one such that the new operation will occupy the last stage at the next cycle. At that point, if a copy of the calculated data is still required, the result can be written-back to the registers, otherwise the apparatus can allow the result to be overwritten.

In accordance with the techniques described herein, there is therefore provided an apparatus with processing circuitry that comprises one or more execution units that perform operations in response to instructions. The processing circuitry may comprise a central processing unit (CPU) or graphics processing unit (GPU) or parts thereof. In particular, the processing circuitry may comprise an arithmetic logic unit (ALU) or floating point unit (FPU) as may be found in a CPU or GPU. The processing circuitry may in some examples be vector processing circuitry or matrix processing circuitry arranged to operate on and output vectors and matrices respectively or may in some examples be a scalar processor. The execution units may represent elements of the processing circuitry arranged to perform specific types of operation. For example, the execution units could be an arithmetic logic unit (ALU) or a floating point unit (FPU) or sub-units thereof. In some examples, the execution units are functional units of a matrix processor with each execution unit arranged to operate on a particular element or elements of one or more matrix or vector inputs.

The apparatus is further provided with one or more registers to store data accessed by the processing circuitry. Such registers may be scalar registers arranged to store scalar values or may be vector or matrix registers comprising multiple elements to store vector or matrix data. The one or more registers are in communication with the processing circuitry such that results can be written from the processing circuitry to the registers and read from the registers by the processing circuitry in order to carry out operations on the data stored in those registers.

To support the forwarding of results of the operations from the one or more execution units of the processing circuitry to the registers, there is also provided forwarding circuitry. In addition to being able to forward results from the execution units to the registers, the forwarding circuitry is provided with forwarding paths from the output of at least some of the execution units to the inputs of at least some of the execution units. As such, the forwarding circuitry is able to selectively forward results of the operations from execution units to be used as the operands for further operations being carried out by the execution units without writing the result back to the register, thereby bypassing the register bank and the write-back process.

To control the operation of this forwarding circuitry, write-back reschedule circuitry is provided. The write-back reschedule circuitry causes the execution unit or units to stall their operations at a stage prior to a write-back stage of the execution unit. To effect this stalling, the write-back reschedule circuitry may issue control signals to the execution unit or units. Thus, if the write-back stage is the final stage of the execution unit, the write-back reschedule circuitry may be configured to cause the operation to be stalled at a penultimate (or earlier) stage of the execution unit. In some examples however, write-back is not considered to be a stage of the execution itself and so the operation may be stalled at a final (or earlier) stage of the execution unit. By stalling the operation, the operation is prevented from being written back to the registers for at least the period during which the operation is stalled.

The write-back reschedule circuitry then monitors the upcoming operations to be executed by the processing circuitry to identify whether the operands of an upcoming operation can be obtained by forwarding directly from the execution unit rather than by reading from the registers. The write-back reschedule circuitry also determines whether the result of an operation obtained by an execution unit needs to be written-back to the registers. Based on these determinations, the write-back reschedule circuitry controls the forwarding circuitry to selectively forward the result to the execution units for use as an operand or to the registers for write-back.

By controlling the forwarding in this way, the number of results that need to be written back to the registers may be reduced. In situations where the result will not be read from the register to which it would be written, the write-back reschedule circuitry may identify that there is no need to effect the write-back and so may allow the result stalled in the execution unit to be overwritten by the result of a subsequent operation. Thus, the power consumption involved in performing the write-back can be avoided.

Moreover, by reducing the number of write-back operations that need to be carried out, the forwarding logic between the execution units and the registers can be simplified. This is particularly the case where the processing circuitry has a large number of execution units, since the forwarding logic no longer has to handle so many results, each of which may require a separate control signal to indicate how that result should be forwarded.

To monitor the upcoming operations to be performed by the processing circuitry, the write-back reschedule circuitry may be arranged to reference an issue queue containing upcoming instructions to be executed by processing circuitry or a separate data structure may be maintained indicating the operations to be executed by the execution units. To identify upcoming operations that may be relevant to the stalled operation in a particular execution unit, the write-back reschedule circuitry may identify subsequent operations that reference a same register as the stalled operation. For example, if a subsequent operation reads from the same register as the stalled operation, the write-back reschedule circuitry may determine that the result of the stalled operation can be forwarded directly for use as an operand of the execution unit handling that subsequent operation. On the other hand, if a subsequent operation writes to the same register as the stalled operation such that the result of the stalled operation would be overwritten by the subsequent operation, the write-back reschedule circuitry may suppress a write-back of the result of the stalled operation to avoid unnecessarily incurring the power/performance cost of performing the write-back.

As used herein, the term ‘operation’ refers to a calculation or element of processing that is performed by the execution unit. The precise form that the operation takes may depend on the apparatus, the processing circuitry or the execution unit handling the operation. In some examples, the operations will correspond directly to instructions being executed by the processing circuitry such that each instruction is an operation. However, in some examples, the operations referred to herein correspond micro-operations generated by decode circuitry of the apparatus. If the micro-operations are further divided or combined, the operations may correspond more generally to whichever tasks are handled by the execution units.

As used herein, the term ‘result’ refers to a data value or data values produced by the execution unit in performing the operation. Thus the result may comprise more than one data value where the operation produces more than one data value.

In some examples, the write-back reschedule circuitry is configured to identify when the result of the stalled operation is about to be overwritten in the execution unit by a subsequent operation and to halt stalling the operation to allow the result to be written-back to the registers so as to avoid the result being overwritten. This may be done where the write-back reschedule circuitry identifies that the result of the stalled operation will be needed again or cannot identify that the result will not be needed and so to preserve the result, the write-back is carried out. Thus, where the write-back reschedule circuitry identifies a subsequent operation performed by the same execution unit that is due to occupy the stage at which the first operation is stalled, the write-back reschedule circuitry may cause the result to be stored to the registers.

In some examples, the write-back reschedule circuitry is configured to identify a subsequent operation that uses the result of the stalled operation and on this basis control the forwarding circuitry to forward the result to the execution unit handling that subsequent operation. This could be the same execution unit or may be a different execution unit where more than one execution unit is provided. Thus, in the case where the result of the stalled operation is to be used while the operation is still stalled, the result may be forwarded directly to the execution unit for use as an operand.

The write-back reschedule circuitry may identify the subsequent operation that uses the result based on that subsequent operation reading from a particular register to which the result of the operation is due to be written. As such, were the result of the stalled operation to be written-back to the registers, that result would be read by the subsequent operation and used as its operand. By forwarding the result directly between the execution units, this write-back process can thereby be avoided.

In some examples, the stalled operation may be unstalled at this point and the result also written-back to the registers. This may be the case where another operation will or is likely to use the result or where it cannot be determined if the result will otherwise be used. However, in some cases, the stalled operation may be kept stalled in the execution unit in case any further subsequent operations make use of the result or until it is determined that the result should be written-back to the registers or allowed to be overwritten.

Therefore, in certain cases where the subsequent operation both uses the result of the stalled operation and overwrites the result (i.e., the subsequent operation reads from and writes to the same register as targeted by the stalled operation), the write-back reschedule circuitry may control the forwarding circuitry to forward the result of the stalled operation to the one or more execution units for use as an operand and allow the stalled operation to be overwritten in the execution unit handling that operation.

For certain types of workload in particular, it is particularly common that results do not need to be written back because before the result is written back to register bank, it can be forwarded for use in another accumulation-type operation which will overwrite the same register. For such accumulation-type workloads, significant savings can therefore be made by avoiding these write-back operations.

To increase the likelihood of being able to forward the result of the stalled operation onto another execution unit or being able to discard the result without writing it back to the registers, the write-back reschedule circuitry may employ an aggressive policy for delaying the write-back. In such examples, the write-back reschedule circuitry is configured to cause the execution unit to stall the operation until the write-back reschedule circuitry identifies either a subsequent operation that uses the result of the stalled operation (whereupon the result can be forwarded to the execution unit handling that subsequent operation) or a subsequent operation performed by the same execution unit that is due to occupy the stage at which the operation was stalled (at which point the result of the stalled operation can be allowed to be overwritten or written-back to the registers, as appropriate). This ensures that the stalled operation is held in the execution for as long as possible, thereby increasing the possibility that a subsequent operation that overwrites and/or makes use of the result will be identified.

Another way in which the write-back reschedule circuitry may be configured to aggressively implement the techniques described herein is by delaying determination of whether and where to forward the result of the stalled operation until the subsequent operation has reached a stage in the execution unit immediately prior to a stage at which the operation is stalled. That is, rather than just waiting until a subsequent operation that is identified that will overwrite the result of the operation to forward the result of the stalled operation, the write-back reschedule circuitry may in some examples only check to whether there is a valid result at the last stage of the execution unit when the subsequent operation reaches the penultimate stage of the execution unit. Again this may be done to increase the likelihood that the write-back operation for the stalled operation can be avoided.

To keep track of the operations being handled by the execution units, data location tracking circuitry may be provided to maintain information regarding these operations. For example, the information may identify for each operation, the execution unit to which the operation has been allocated and a number of clock cycles until the operation reaches a stage at which it is to be stalled (e.g., the stage immediately prior to the write-back stage). Once an operation is allocated to an execution unit, the data location tracking circuitry may add an indication of the operation identifying these values. The number of clock cycles until the operation reaches a stage at which it is to be stalled can then be updated as the operation progresses. Once an operation has been stalled, this may be indicated or otherwise derivable from the information, allowing the data location tracking circuitry to identify data that is able to be forwarded. The write-back reschedule circuitry may reference this information in order to determine whether and how to forward the result of the operations. For example, the information may be used to identify where an upcoming operation being handled by an execution unit will overwrite a stalled operation in that execution unit and so allow the result of the stalled operation to be forwarded (e.g., for write-back) before it is overwritten.

The use of this data location tracking circuitry in combination with the approach to rescheduling write-back may simplify the forwarding logic that would otherwise need to be provided. As already explained, the techniques described herein may reduce the number of write-back operations that need to be performed and so where multiple execution units are provided, the number of concurrent write-back operations that need to be performed from the different execution units may also be reduced. Thus, the forwarding logic to handle write-back operations can be simplified. Moreover, by maintaining information identifying the location of pieces of data, the logic that is provided to generate forwarding control signals is able to operate by identifying the location of data based on the information maintained by the data location tracking circuitry and indicating where this should be forwarded—a more consistent and logistically simpler form of operation than may otherwise be required if every result was forwarded as soon as it was calculated by the execution units.

Another way in which the write-back reschedule circuitry is able to make use of the ability to reschedule when results are written back to the registers is in avoiding write-back conflicts. Write-back conflicts can occur where two or more results are to be written-back to the registers using the same write-back port at the same time (i.e., on the same clock cycle). This may occur for example where multiple execution units share a write-back port. Rather than only writing back results when it is identified that those results are about to be overwritten, where a write-back conflict is anticipated (i.e., where the write-back reschedule circuitry identifies that more than one execution unit will attempt to write-back using the same write-back port on the same cycle), the write-back reschedule circuitry may be arranged to reschedule the write-backs so that the results can be forwarded on different clock cycles.

The write-back reschedule circuitry may detect a write-back conflict where two or more conflicting operations are scheduled to reach a write-back stage of respective execution units at the same clock cycle. This may be identified for example based on the information maintained by the data location tracking circuitry.

This could occur for example due to the execution units having been issued their respective operations at the same time. As such, if the operations take the same amount of time to complete, then these operations will reach the write-back stage at the same time. However, even where the execution units that share the write-back port also share an issue queue that has a constrained bandwidth, such conflicts can occur. For example, if a collection of execution units share a write-back port having a bandwidth of one result per cycle and share an issue queue having a bandwidth of one operation per cycle, a conflict could nonetheless occur if the operations execute with different latencies. This may be the case where the execution units themselves have different associated latencies or where the operations are of different types and the types of operation have different latencies.

Once a write-back conflict has been identified, the write-back reschedule circuitry may cause at least one of the execution units sharing the write-back port to stall a respective conflicting operation to allow the conflicting operations to be forwarded on separate clock cycles. Thus, by rescheduling the write-back of operations, it is possible to avoid write-back conflicts even in situations where a large number of execution units are provided and operations execute with different latencies.

Although the present techniques could be employed in processors of a range of forms including scalar processors, the ability to reschedule the write-back of operations as discussed herein may be particular valuable in the context of vector and matrix processors.

Vector and matrix processors often contain multiple execution units to process different data operations. To improve performance, a large number of execution units may be provided and there may be different latencies for different operations and different execution units. As a result, the power consumed by vector or matrix processors can be particularly high and the register bank write-back conflict can be a functional issue which limits the performance of the processors. As such, by reducing the occurrence of write-back operations and by allowing write-backs to be rescheduled to avoid write-back conflict as discussed above, apparatuses comprising matrix or vector processes in particular may benefit.

In addition, in a matrix processor, the number of forwarding possibilities can become very large since the forwarding choice for each element of the matrix could be different. For example, it is possible that results can be forwarded between an outer-product operation and a multi-vector operation or between two multi-vector operations whose destination vectors have a partial overlap, or even between data-processing operations and vertical MOV operations. Thus, individual forwarding control would have to be provided for each of these possibilities. Since the matrix processor may comprise execution units located in two dimensions and given the large amount of possible destination vector combination of multi-vector operations, the possibilities of different forwarding cases become too numerous to be supported by simple forwarding controls. However, by providing the write-back reschedule circuitry and data location tracking circuitry, it is possible to simplify control of the forwarding since the location of each data element can be indicated the information maintained by the data location tracking circuitry.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Particular examples will now be described with reference to the figures.

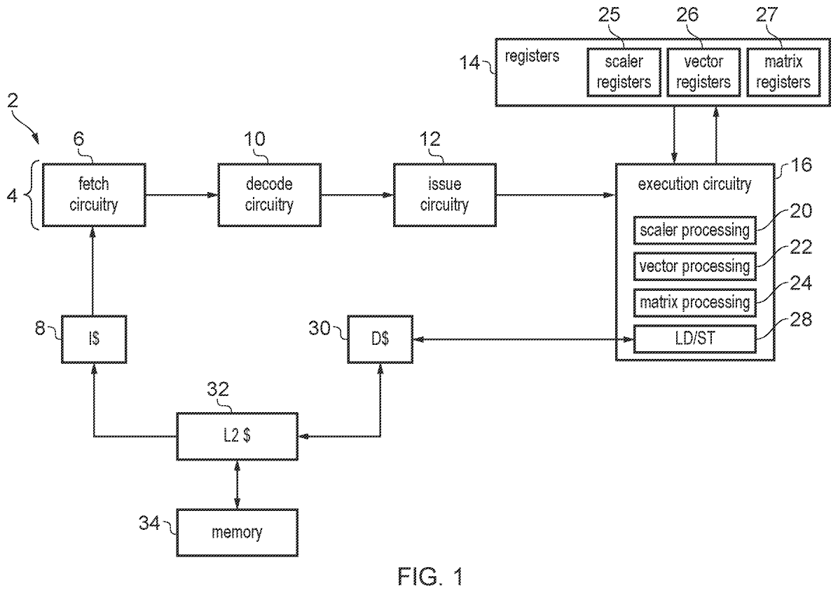

FIG. 1 schematically illustrates an example of a data processing apparatus 2. The data processing apparatus has a processing pipeline 4 which includes a number of pipeline stages, each implemented by corresponding circuitry. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values. The result values can then be written-back to the register file 14. It will be appreciated that this is merely one example of a possible pipeline arrangement, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar processing unit 20 (e.g. comprising a scalar arithmetic/logic unit (ALU) 20 for performing arithmetic or logical operations on scalar operands read from the registers 14); a vector processing unit 22 for performing vector operations on vectors comprising multiple data elements; a matrix processing unit 24 for performing matrix operations on vectors and matrices; and a load/store unit 28 for performing load/store operations to access data in a memory system 8, 30, 32, 34. Other examples of processing units which could be provided at the execute stage could include a floating-point unit for performing operations involving values represented in floating-point format, or a branch unit for processing branch instructions.

The registers 14 include scalar registers 25 for storing scalar values, vector registers 26 for storing vector values, and matrix registers 27 for storing matrix values.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline arrangement, and the processor may include many other elements not illustrated for conciseness.

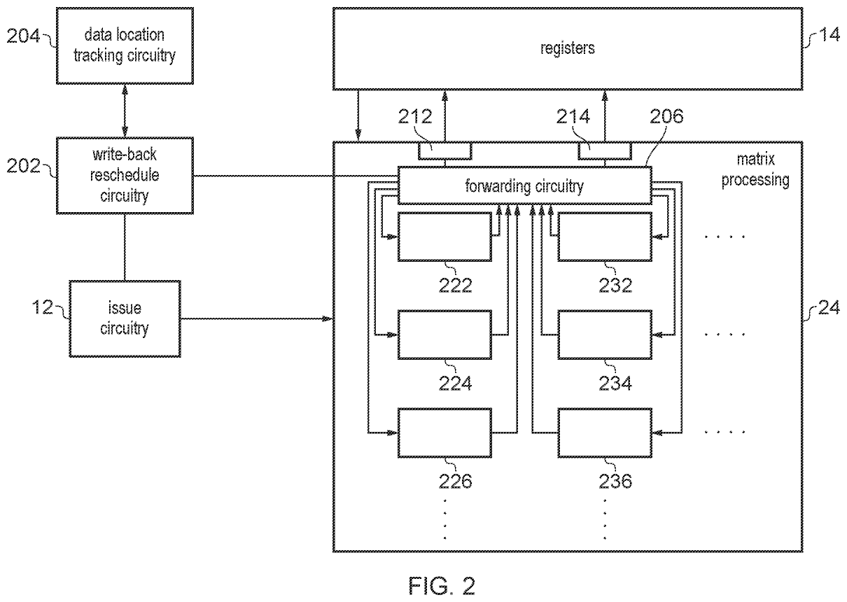

FIG. 2 schematically illustrates various components of the apparatus 2 of FIG. 1 in more detail. Shown in FIG. 2 there is the matrix processing circuitry 24 of FIG. 1 in communication with the register file 14. Although the operation of the matrix processing circuitry 24 will be described in detail with reference to FIG. 1, it will be appreciated that corresponding features and functionality may be provided in respect of the scalar processing circuitry 20, vector processing circuitry 22 or any other processing circuitry that may be provided.

The matrix processing circuitry 24 (or processing circuitry more generally) is provided with a plurality of execution units 222-226, 232-236 to perform operations received from issue circuitry 12. The execution units 222-226, 232-236 may be arranged to operate on different elements of a matrix or vector such that together the execution units 222-226, 232-236 may be used to perform operations on matrix/vector operands.

Forwarding circuitry 206 is provided to route the results of the operations performed by the execution units 222-226, 232-236 to the registers 14 via the write-back ports 212, 214. Thus, once the execution units 222-226, 232-236 have calculated the results, the results can be written-back to the registers 14 for use by other execution units 222-226, 232-236 as operands for further operations or stored in the memory system 8, 30, 32, 34 for example.

However, if each result is written-back as soon as it is calculated, since each execution unit 222-226, 232-236 may produce a result to be forwarded and since the forwarding choice for each result may be different, the forwarding circuitry may need to support a large number of combinations of possible forwarding paths with logic to control this forwarding. Additionally, this approach has a considerable power consumption cost due to the need to operate forwarding logic to carry out all of these write-back operations.

In the apparatus of FIG. 2 however, write-back reschedule circuitry 202 is provided to control when and whether results are written back from the execution units 222-226, 232-236 to the registers 14. The write-back reschedule circuitry 202 is configured to reference data location tracking circuitry 204 that maintains information regarding the operations that are being processed in order to determine how and when to forward the results.

Rather than allowing each result to be written-back from the execution units 222-226, 232-236 as soon as they are calculated, the write-back reschedule circuitry 202 is configured to stall the operations in the execution units 222-226, 232-236 once the operations have reached a stage prior to a stage at which they would be written-back to the registers 14. In this way, the write-back reschedule circuitry 202 is able to temporarily restrict the execution units 222-226, 232-236 from writing back the results.

Based on monitoring upcoming operations to be handled by the execution units 222-226, 232-236, the write-back reschedule circuitry 202 then controls the execution units 222-226, 232-236 to either forward the results to be written-back to the registers 14, forward the results for use as an operand of a further operation by the same or another execution unit and/or allow the result to be overwritten by the result of that subsequent operation. The write-back reschedule circuitry may identify which of these actions to take based on monitoring the issue circuitry 12 and/or by monitoring the information maintained by the data location tracking circuitry 204.

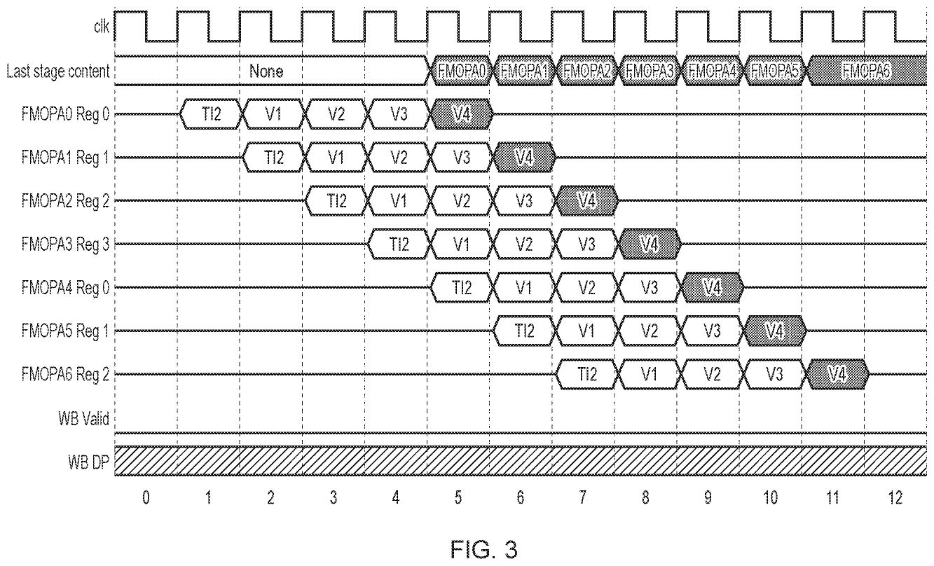

Examples of the operation of the write-back reschedule circuitry 202 to control this selective forwarding will now be discussed with reference to FIGS. 3-5.

FIG. 3 is a timing diagram with a worked example where results are forwarded from an execution unit to be used as the operand of a subsequent operation. FIG. 3 illustrates the operations being handled by a particular execution unit and the scheduling of those operations. A clock signal used to synchronise the timing of actions performed within the apparatus is shown in FIG. 3. In the example of FIG. 3, each operation takes four clock cycles to complete as illustrated with stages V1, V2, V3, and V4 of the execution unit. The TI2 stage represents an operand preparation stage rather than an execution stage such that, for example, the result of FMOPA0 can be forwarded from its V4 stage to FMOPA4 at its TI2 stage at cycle 5 to be prepared as an operand of that FMOPA4 operation. As the operation progresses within the execution unit, the operation moves between the stages. The execution unit is able to handle multiple operations in a pipelined manner with a different operation occupying each stage within the execution unit.

FIG. 3 illustrates the progression of each of several operations being handled by the execution unit. Initially an operation FMOPA0 is to be handled. This operation targets the register Reg 0 such that in the absence of any write-back rescheduling the result of the operation is to be written-back to Reg 0. As FMOPA0 is handled, this operation transitions through the stages of the execution unit from TI2 to V4. With FMOPA0 having commenced at clock cycle 1, another operation, FMOPA1, which targets Reg 1 is able to commence at clock cycle 2. Similarly, at clock cycle 3, since FMOPA0 and FMOPA1 have both progressed, FMOPA2 is able to be commenced. This continues for each of the operations FMOPA0 to FMOPA6.

At clock cycle 5, the operation FMOPA0 reaches stage V4 which is immediately prior to the stage at which the result of the operation is to be written-back to the registers. However, in this case a subsequent operation, FMOPA4, is about to commence. FMOPA4 reads from and writes to the register, Reg 0, which was the register to which FMOPA0 would have written its data. As such, the data that FMOPA4 is to read is the data present in the last stage of the execution unit at clock cycle 5, as illustrated in the ‘Last stage content’ line in FIG. 3. As such, rather than writing the data from the execution unit to Reg 0 only for the data to then be read back into the execution unit as an operand of FMOPA4, the data is instead forwarded directly to the input of the execution unit for use as the operand of FMOPA4. In this way, the result of FMOPA0 can be more quickly forwarded for use by FMOPA4.

Additionally, since FMOPA4 will also write to Reg 0 and since no other operation reads from Reg 0, if the result of FMOPA0 were to be written-back to Reg 0, it would later be overwritten by the result of FMOPA4 before being used. As such, the write-back reschedule circuitry is arranged to suppress the write-back, allowing the result to be forwarded for use by another operation but avoiding any write-back to the registers.

On the next cycle, cycle 6, a similar process can be performed. The last stage of the execution unit now stores the result of FMOPA1, this operation targeting Reg 1. However, rather than writing this result back to the registers, this result can again be forwarded straight back to the execution unit for use as an input to operation FMOPA5, which reads from Reg 1. Again, this avoids the need for any write-back to the registers in respect of FMOPA1. A similar process can be carried out for FMOPA6 to make use of the result of FMOPA2.

With this approach taken, it can be seen in the last two lines of FIG. 3 that no write-back has occurred with the results of the operations forwarded directly from the final stage of the execution unit to the input of the execution unit for use as an operand of a further operation. Thus, by identifying where results present in the execution unit may be used directly as inputs to further operations, the number of write-back operations that need to be performed can be reduced. This is particularly the case for workloads involving accumulation where particular registers are updated repeatedly.

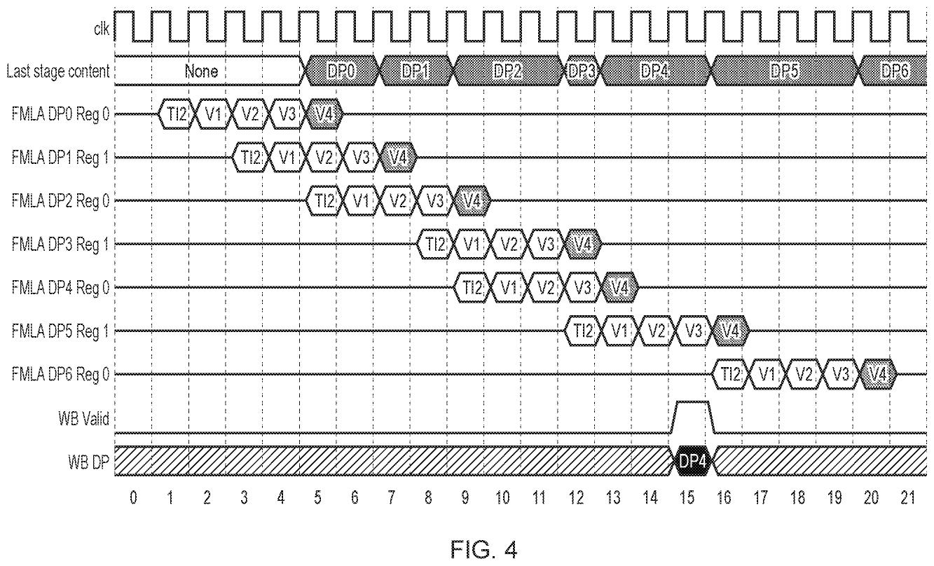

FIG. 4 is a timing diagram with a worked example where a result is forwarded to be written-back. As with FIG. 3, a clock signal is used to synchronise the operations of the execution unit, with the execution unit handling operations FMLA DP0 to FMLA DP6, each operation taking five cycles to complete.

Once the operation FMLA DP0 has reached its final stage, V4, the write-back reschedule circuitry issues a control signal to the execution unit to cause the execution unit to stall the operation at the V4 stage. As such, the result of operation DP0 is kept in the last stage as is illustrated in the ‘Last stage content’ line of FIG. 4. Another operation, FMLA DP2 also targets the same register as operation DP0 and so the result of the DP0 operation can be forwarded to the execution unit for use as the operand of FMLA DP2 at clock cycle 5.

At clock cycle 7, the DP0 result in the last stage of the execution unit will be overwritten as the next operation, FMLA DP1, reaches the final stage of the execution unit. Since the result of the DP0 operation has already been forwarded for use by the DP2 operation, and since the result of the DP0 operation will be overwritten by the result of the DP2 operation, the write-back reschedule circuitry may allow the DP0 result to be overwritten in the last stage of the execution unit without being written back to the registers.

Similarly, once the DP1 operation has reached its final stage of operation at clock cycle 7, the result can be stalled in the execution unit. Although at this stage, there is no subsequent operation able to make use of the result, there is also no subsequent operation that will overwrite the result in the last stage of the execution unit on the next cycle and so the result can be allowed to occupy the final stage of the execution unit during this period. On the next clock cycle however, at clock cycle 8, the operation FMLA DP3 makes use of the result of the DP1 operation and so the result can be forwarded directly to the execution unit to use as the input of this operation. Thus by stalling the operation, even where there was not a subsequent operation able to use the result straight away, the result could be kept at the final stage and later be forwarded directly for use as an operand of a further operation without the need to write-back the result to the registers.

The FMLA DP4 operation is similarly able to make use of the result of the DP2 operation with the result forwarded directly and the FMLA DP5 operation is able to make use of the FP3 operation. At clock cycle 12, the DP4 operation reaches a final stage of the execution unit and is thus stalled. While the FMLA DP6 operation will make use of the result of the DP4 operation since they both target the same register, the DP6 operation is not scheduled to commence until clock cycle 16. However, at clock cycle 16, the DP5 operation will reach the final stage of operation and hence overwrite the contents of the final stage. Consequently, the result of the DP4 operation cannot be forwarded directly from the final stage of the execution unit to be used as the operand of the DP6 operation. Instead, the write-back reschedule circuitry detects that the DP5 operation will overwrite the result of the DP4 operation at clock cycle 16 and that this result is needed by the DP6 operation. The write-back reschedule circuitry is therefore configured to cause the result of the DP4 operation to be written-back to the registers at clock cycle 15 so that this result is not overwritten. The DP6 operation can then access the result from the registers. In this way, the write-back reschedule circuitry is able to selectively stall the operations and forward the results in order to reduce the number of write-back operations that need to be carried out, ensuring that results are not lost where the result will be overwritten in the execution unit.

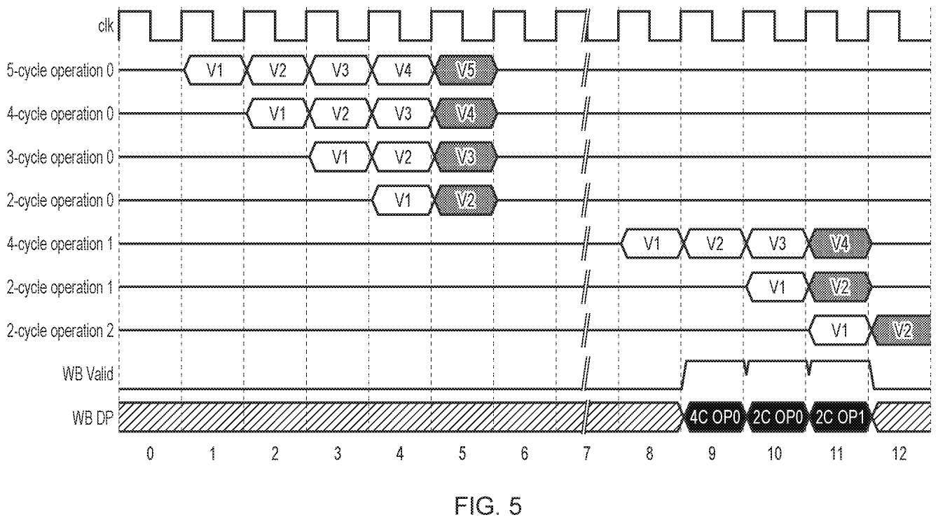

FIG. 5 is a timing diagram with a worked example where write-back of results is rescheduled to avoid a write-back conflict. Another way in which the write-back rescheduling may operate is to avoid write-back conflicts where more write-back operations are scheduled to occur than bandwidth available for handling those write-backs.

In the example of FIG. 5, four different execution units are provided, each being associated with a different latency. The execution units all share an issue queue and a write-back port, each of which has a bandwidth of one operation/result per cycle. Although the issue queue and the write-back port have the same bandwidth, since the execution units operate with different latencies, it is nonetheless possible to end up with a situation where more than one result is to be written-back over the write-back port at the same time.

In the example of FIG. 5, the 5-cycle execution unit (having a latency of five cycles) commences an operation at cycle 1 with the other execution units commencing operations at clock cycles 2, 3, and 4 respectively. Given the difference in latencies, all of the operations reach a final stage in their respective execution units at clock cycle 5.

All of these operations are stalled in their respective execution units since they do not yet need to be written-back or forwarded to another execution unit. Later, at clock cycle 8, a subsequent and independent operation is commenced at the 4-cycle execution unit. At clock cycle 10, another operation (which does not make use of the result of the previous operation) is commenced at the 2-cycle execution unit and at clock cycle 11, an operation is commenced at the 2-cycle execution unit. At clock cycle 11, the last stage content of both the 4-cycle execution unit and the 2-cycle execution unit will be overwritten by respective operations. Thus, if the results of the original operations already carried out and maintained in the last stages of these execution units were to be forwarded for write-back immediately before the results were overwritten by the subsequent operations, both the 4-cycle execution unit and the 2-cycle execution unit would be attempting to write-back using the same port at clock cycle 10 and so a write-back conflict would arise where both of these results could not be written-back.

Instead however, the write-back reschedule circuitry is arranged to identify the write-back conflict and reschedule the write-back operations from the 4-cycle and 2-cycle executions to avoid the conflict. In this example therefore, the write-back reschedule circuitry reschedules the write-back from the 4-cycle execution unit to occur earlier on clock cycle 9. On clock cycle 10, the result from the 2-cycle execution unit can be written back thereby conserving the result of the original operations while allowing the results to be overwritten in the execution units.

The 2-cycle execution unit handles a further operation that will overwrite the result of 2-cycle operation 1 in the final stage of the 2-cycle execution unit at clock cycle 12 and so at clock cycle 11, the result of 2-cycle operation 1 is also written-back to the registers.

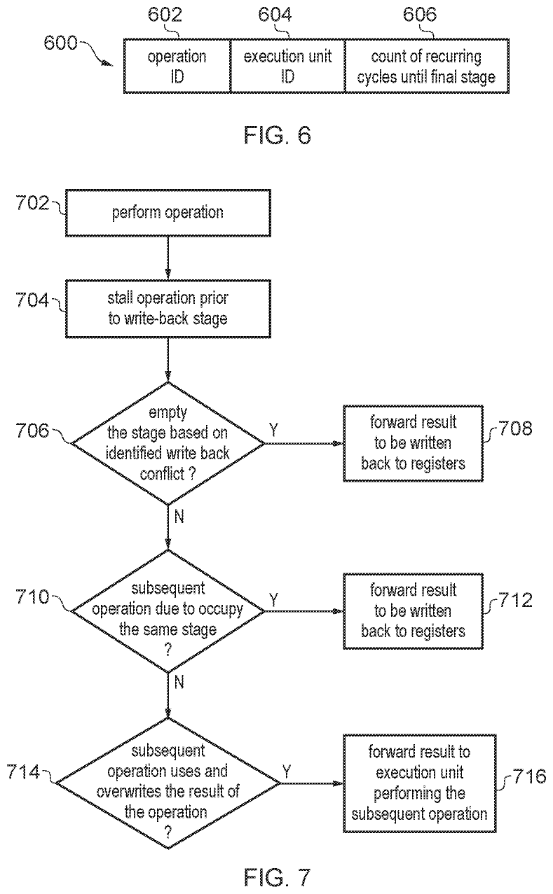

To identify write-back conflicts and track the location of results/data items that have been or will be calculated by the processing circuitry, the data location storage circuitry 204 maintains information regarding the operations being handled for reference by the write-back reschedule circuitry 202. FIG. 6 schematically illustrates an entry 600 in the information maintained by the data location tracking circuitry 204.

The entry 600 comprises an operation identifier (ID) 602 to identify which operation is being referenced. The entry 600 also comprises an execution unit ID 604 indicative of the execution unit to which the operation has been allocated. Finally, the entry 600 contains a count of the remaining cycles until the operation reaches a final stage of the execution unit 606. Thus, when the count 606 reaches zero, the information indicates that the operation is at the final stage of the execution unit and able to be forwarded. The write-back reschedule circuitry can reference the information to identify where an operation is approaching the final stage of the execution unit and should be stalled, where a subsequent operation is about to overwrite a stalled operation and so determine whether/where the stalled operation should be forwarded and identify where more than one execution unit will need to write-back a result at the same time in a manner that would exceed the bandwidth of the write-back port handling the write-backs (i.e., a write-back conflict).

FIG. 7 is a flow diagram illustrating the re-scheduling of write-back for a particular operation. At step 702, an execution unit begins performing an operation. This operation may be performed in several stages before the execution unit can write-back the results of the operation, once calculated, to a register or registers of a register file.

Before the operation is written-back, at step 704, the operation is stalled at a stage prior to the write-back stage at which the write-back would occur. Thus, the write-back is temporarily prevented.

The write-back reschedule circuitry 706 then monitors, for example with reference to the information maintained by the data location tracking circuitry, upcoming operations to identify potential write-back conflicts and subsequent operations that would overwrite the result in the last stage of the execution unit or make use of the result of the stalled operation.

At step 706 therefore, if a write-back conflict has been detected by the write-back reschedule circuitry, the write-back reschedule circuitry determines whether the stage at which the operation is stalled should be emptied in order to avoid the write-back conflict. If so, then the write-back reschedule circuitry causes the execution unit to forward to the result of that stalled operation to be written back to the registers at step 708.

Otherwise, the method proceeds to step 710 at which the write-back reschedule circuitry determines whether a subsequent operation is due to occupy the same stage as the stalled operation, thereby overwriting the result of the stalled operation in the execution unit. If this is the case and the result is still needed, then the stalled operation is unstalled and the result is allowed to be written-back to the registers at step 712.

If however, the write-back reschedule circuitry identifies at step 714 a subsequent operation that makes use of the result of the stalled operation and overwrites that result (will write to the same register as the stalled operation), the write-back reschedule circuitry may cause the execution unit to forward the result at step 716 to the execution unit that is performing the subsequent operation thereby avoiding the need to write-back the result to the registers.

Thus there has been described an apparatus, method and a computer-readable medium for fabrication of an apparatus that is able to delay the writing back of results from processing circuitry in order to avoid write-back conflicts, make use of forwarding directly between execution units rather than results being passed via the registers, and avoid write-backs to registers in certain cases.

The techniques described herein are illustrated with the following numbered examples.

Example 1. An apparatus comprising:
processing circuitry comprising one or more execution units, the one or more execution units configured to perform operations in response to instructions;
one or more registers to store data accessed by the processing circuitry;
forwarding circuitry to selectively forward results of the operations from the one or more execution units to be written back to the one or more registers and to the one or more execution units for use as operands of further operations;
write-back reschedule circuitry configured to, for each operation:
   cause an execution unit performing the operation to stall the operation prior to a write-back stage of the execution unit, wherein stalling the operation prevents a result of the operation being written back to the registers while the operation is stalled;
   determine, based on monitoring subsequent operations to be performed by the processing circuitry, whether to forward the result of the operation to be written back to a register of the one or more registers or to forward the result to an execution unit of the one or more execution units; and
   control the forwarding circuitry to forward the result according to the determination.

Example 2. The apparatus according to example 1, wherein:
the write-back reschedule circuitry is configured to control the forwarding circuitry to forward the result to be written-back to a register of the one or more registers in response to identifying a subsequent operation performed by the same execution unit that is due to occupy the stage at which the operation was stalled.

Example 3. The apparatus according to example 1 or example 2, wherein:
the write-back reschedule circuitry is configured to control the forwarding circuitry to forward the result to an execution unit of the one or more execution units in response to identifying a subsequent operation that overwrites the result.

Example 4. The apparatus according to example 3, wherein:
the write-back reschedule circuitry is configured to control the forwarding circuitry to forward the result to an execution unit of the one or more execution units and to allow the result stored at the stage at which the operation was stored to be overwritten without writing back the result to the registers in response to identifying a subsequent operation that uses and overwrites the result.

Example 5. The apparatus according to example 3 or example 4, wherein:
the write-back reschedule circuitry is configured to identify the subsequent operation that uses the result based on the subsequent operation reading from a particular register to which the result of the operation is due to be written.

Example 6. The apparatus according to any preceding example, wherein:
the write-back reschedule circuitry is configured to cause the execution unit to stall the operation prior to the write-back stage of the execution unit until the write-back reschedule circuitry identifies at least one of:
   a subsequent operation performed by the same execution unit that is due to occupy the stage at which the operation was stalled; and
   a subsequent operation that uses the result of the operation.

Example 7. The apparatus according to any preceding example, wherein:
each execution unit has a plurality of stages; and
the write-back reschedule circuitry is configured to delay the determination of whether to forward the result of the operation to be written back to a register of the one or more registers or to forward the result to an execution unit of the one or more execution units until a subsequent operation has reached a stage in the execution unit immediately prior to a stage at which the operation is stalled.

Example 8. The apparatus according to any preceding example, wherein:
each execution unit has a plurality of stages; and
the write-back reschedule circuitry is configured to, for each operation, stall the operation at a stage immediately prior to the write-back stage of the execution unit.

Example 9. The apparatus according to any preceding example, the apparatus further comprising:
data location tracking circuitry to maintain information identifying, for each of a plurality of operations, the execution unit to which the operation was allocated and a number of clock cycles until the operation reaches a stage immediately prior to the write-back stage of the execution unit;
wherein the write-back reschedule circuitry is configured to reference the information maintained by the data location tracking circuitry to determine whether to forward the result of the operation to be written back to a register of the one or more registers or to forward the result to an execution unit of the one or more execution units.

Example 10. The apparatus according to any preceding example, wherein
the write-back reschedule circuitry is configured to detect a write-back conflict where two or more conflicting operations performed by execution units sharing a write-back port are scheduled to reach a write-back stage of the respective execution units at the same clock cycle; and
the write-back reschedule circuitry is responsive to detection of the write-back conflict to cause at least one of the execution units sharing the write-back port to stall a respective conflicting operation of the conflicting operations and to control the forwarding circuitry to forward results of the conflicting operations on different clock cycles.

Example 11. The apparatus according to example 10, wherein:
the execution units sharing the write-back port have different associated latencies.

Example 12. The apparatus according to example 10 or example 11, wherein:
the execution units sharing the write-back port are operable to perform at least two types of operation; and
the types of operation are performed with different latencies.

Example 13. The apparatus according to any preceding example, wherein:
the processing circuitry comprises a matrix processor.

Example 14. The apparatus according to any preceding example, wherein:
the processing circuitry comprises a vector processor.

Example 15. A method of rescheduling write-back of operations, the method comprising:
performing, by one or more execution units, operations in response to instructions;
storing, by one or more registers, data accessed for performing the operations;
selectively forwarding results of the operations to be written back to the one or more registers and to the one or more execution units for use as operands of further operations; and
for each operation:
   stalling the operation prior to a write-back stage of an execution performing the operation, wherein stalling the operation prevents a result of the operation being written back to the registers while the operation is stalled;
   determining, based on monitoring subsequent operations to be performed, whether to forward the result of the operation to be written back to a register of the one or more registers or to forward the result to an execution unit of the one or more execution units; and
   forwarding the result according to the determination.

Example 16. A non-transitory computer-readable medium to store computer-readable code for fabrication of an apparatus comprising:
processing circuitry comprising one or more execution units, the one or more execution units configured to perform operations in response to instructions;
one or more registers to store data accessed by the processing circuitry;
forwarding circuitry to selectively forward results of the operations from the one or more execution units to be written back to the one or more registers and to the one or more execution units for use as operands of further operations;
write-back reschedule circuitry configured to, for each operation:
   cause an execution unit performing the operation to stall the operation prior to a write-back stage of the execution unit, wherein stalling the operation prevents a result of the operation being written back to the registers while the operation is stalled;
   determine, based on monitoring subsequent operations to be performed by the processing circuitry, whether to forward the result of the operation to be written back to a register of the one or more registers or to forward the result to an execution unit of the one or more execution units; and
control the forwarding circuitry to forward the result according to the determination.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. An apparatus comprising:
processing circuitry comprising one or more execution units, the one or more execution units configured to perform operations in response to instructions;
one or more registers to store data accessed by the processing circuitry;
forwarding circuitry to selectively forward results of the operations from the one or more execution units to be written back to the one or more registers and to the one or more execution units for use as operands of further operations;
write-back reschedule circuitry configured to, for each operation:
cause an execution unit performing the operation to stall the operation prior to a write-back stage of the execution unit, wherein stalling the operation prevents a result of the operation being written back to the registers while the operation is stalled;
determine, based on monitoring subsequent operations to be performed by the processing circuitry, whether to forward the result of the operation to be written back to a register of the one or more registers or to forward the result to an execution unit of the one or more execution units; and
control the forwarding circuitry to forward the result according to the determination.

2. The apparatus according to claim 1, wherein:
the write-back reschedule circuitry is configured to control the forwarding circuitry to forward the result to be written-back to a register of the one or more registers in response to identifying a subsequent operation performed by the same execution unit that is due to occupy the stage at which the operation was stalled.

3. The apparatus according to claim 1, wherein:
the write-back reschedule circuitry is configured to control the forwarding circuitry to forward the result to an execution unit of the one or more execution units in response to identifying a subsequent operation that overwrites the result.

4. The apparatus according to claim 3, wherein:
the write-back reschedule circuitry is configured to control the forwarding circuitry to forward the result to an execution unit of the one or more execution units and to allow the result stored at the stage at which the operation was stored to be overwritten without writing back the result to the registers in response to identifying a subsequent operation that uses and overwrites the result.

5. The apparatus according to claim 3, wherein:
the write-back reschedule circuitry is configured to identify the subsequent operation that uses the result based on the subsequent operation reading from a particular register to which the result of the operation is due to be written.

6. The apparatus according to claim 1, wherein:
the write-back reschedule circuitry is configured to cause the execution unit to stall the operation prior to the write-back stage of the execution unit until the write-back reschedule circuitry identifies at least one of:
a subsequent operation performed by the same execution unit that is due to occupy the stage at which the operation was stalled; and
a subsequent operation that uses the result of the operation.

7. The apparatus according to claim 1, wherein:
each execution unit has a plurality of stages; and
the write-back reschedule circuitry is configured to delay the determination of whether to forward the result of the operation to be written back to a register of the one or more registers or to forward the result to an execution unit of the one or more execution units until a subsequent operation has reached a stage in the execution unit immediately prior to a stage at which the operation is stalled.

8. The apparatus according to claim 1, wherein:
each execution unit has a plurality of stages; and
the write-back reschedule circuitry is configured to, for each operation, stall the operation at a stage immediately prior to the write-back stage of the execution unit.

9. The apparatus according to claim 1, the apparatus further comprising:
data location tracking circuitry to maintain information identifying, for each of a plurality of operations, the execution unit to which the operation was allocated and a number of clock cycles until the operation reaches a stage immediately prior to the write-back stage of the execution unit;
wherein the write-back reschedule circuitry is configured to reference the information maintained by the data location tracking circuitry to determine whether to forward the result of the operation to be written back to a register of the one or more registers or to forward the result to an execution unit of the one or more execution units.

10. The apparatus according to claim 1, wherein
the write-back reschedule circuitry is configured to detect a write-back conflict where two or more conflicting operations performed by execution units sharing a write-back port are scheduled to reach a write-back stage of the respective execution units at the same clock cycle; and
the write-back reschedule circuitry is responsive to detection of the write-back conflict to cause at least one of the execution units sharing the write-back port to stall a respective conflicting operation of the conflicting operations and to control the forwarding circuitry to forward results of the conflicting operations on different clock cycles.

11. The apparatus according to claim 10, wherein:
the execution units sharing the write-back port have different associated latencies.

12. The apparatus according to claim 10, wherein:
the execution units sharing the write-back port are operable to perform at least two types of operation; and
the types of operation are performed with different latencies.

13. The apparatus according to claim 1, wherein:
the processing circuitry comprises a matrix processor.

14. The apparatus according to claim 1, wherein:
the processing circuitry comprises a vector processor.

15. A method of rescheduling write-back of operations, the method comprising:
performing, by one or more execution units, operations in response to instructions;
storing, by one or more registers, data accessed for performing the operations;
selectively forwarding results of the operations to be written back to the one or more registers and to the one or more execution units for use as operands of further operations; and
for each operation:
stalling the operation prior to a write-back stage of an execution performing the operation, wherein stalling the operation prevents a result of the operation being written back to the registers while the operation is stalled;
determining, based on monitoring subsequent operations to be performed, whether to forward the result of the operation to be written back to a register of the one or more registers or to forward the result to an execution unit of the one or more execution units; and
forwarding the result according to the determination.

16. A non-transitory computer-readable medium to store computer-readable code for fabrication of an apparatus comprising:
processing circuitry comprising one or more execution units, the one or more execution units configured to perform operations in response to instructions;
one or more registers to store data accessed by the processing circuitry;
forwarding circuitry to selectively forward results of the operations from the one or more execution units to be written back to the one or more registers and to the one or more execution units for use as operands of further operations;
write-back reschedule circuitry configured to, for each operation:
cause an execution unit performing the operation to stall the operation prior to a write-back stage of the execution unit, wherein stalling the operation prevents a result of the operation being written back to the registers while the operation is stalled;
determine, based on monitoring subsequent operations to be performed by the processing circuitry, whether to forward the result of the operation to be written back to a register of the one or more registers or to forward the result to an execution unit of the one or more execution units; and
control the forwarding circuitry to forward the result according to the determination.
